(19) United States
(12) Patent Application Publication
(10) Pub. No.: US 2011/0006902 A1
(43) Pub. Date: Jan. 13, 2011

(54) CUTANEOUS BODY MOVEMENT SENSING APPARATUS

(76) Inventor: Fathi Saigh, Laval (CA)

Correspondence Address: GEORGE A. SEABY;SEABY & ASSOCIATES, 250 CITY CENTRE AVNUE, OTTAWA, ON, K1R6K7, CA

(21) Appl. No.: 12/736,141

(22) PCT Filed: Mar. 12, 2009
(86) PCT No.: PCT/CA2009/000307

§ 371 Date: Sep. 14, 2010

Related U.S. Application Data
(60) Provisional application No. 61/064,606, filed on Mar. 14, 2008.

(51) Int. Cl. G08B 23/00

(52) U.S. Cl. 340/573.1

(57) ABSTRACT

A body movement sensing apparatus includes a thin, flexible resilient pad with a layer of adhesive on one surface thereof for attaching the pad to a human body. At least one flexible motion sensor such as a Wheatstone bridge in the pad flexes with the pad when there is movement of an area of the body beneath the pad. The sensor is connected to an indicator for providing an audible or visible indication of body movement exceeding a predetermined limit. The sensor can also be a spring metal or other strip which makes a noise when flexed.

### TECHNICAL FIELD

This invention relates to a cutaneous body movement sensing apparatus.

### BACKGROUND ART

There are several devices for sensing and measuring movements and strains on parts of the human body described in the patent literature. Examples of such devices are disclosed by CA 1,193,881 (J. A. Nicholas et al) issued Sep. 24, 1985; CA 1,257,360 (Gregory A. Fraser et al) issued Jul. 11, 1989; CA 2,020,761 (Barry J. French) filed Jul. 9, 1990; U.S. Pat. No. 4,108,164 (Henry W. Hall, Sr.) issued Aug. 22, 1978; U.S. Pat. No. 4,444,205 (John Jackson) issued Apr. 24, 1984; U.S. Pat. No. 4,665,388 (Bernard Ivie et al) issued May 12, 1987; U.S. Pat. No. 4,667,685 (Edward J. Fine) issued May 26, 1987; U.S. Pat. No. 5,064,192 (Arthur A. Smith) issued Nov. 12, 1991; U.S. Pat. No. 5,099,702 (Barry J. French) issued Mar. 31, 1992; U.S. Pat. No. 5,146,929 (James A. Sawhill) issued Sep. 15, 1992; U.S. Pat. No. 5,226,417 (David B. Swedlow et al) issued Jul. 13, 1993; U.S. Pat. No. 5,745,028 (Allan G. Hock) issued Apr. 28, 1998; U.S. Pat. No. 6,032,530 (Allan G. Hock) issued Mar. 7, 2000; US 6,119,516 (Allan G. Hock) issued Sep. 19, 2000 and U.S. Pat. No. 6,487,906 (Allan G. Hock) issued Dec. 2, 2002.

The two main methods employed by the devices described in the literature rely on clothing carrying a sensor in a particular location for activation by body movement, and a band containing a sensor which is wrapped around the location of the body to be monitored. Because clothing naturally shifts from its original location on the body during movement, the use of clothing with a built-in sensor would not achieve the desired result. The use of a band also would not provide accurate results, since bands can rotate, slide or otherwise move from their original location during body movement.

Accordingly, a need exists for a body movement monitor which remains fixed in one position regardless of whether the wearer is moving or stationary.

### DISCLOSURE OF INVENTION

An object of the present invention is to meet the above defined need by providing a relatively simple apparatus for monitoring body movement, which can be worn in a variety of locations on a human body, and which can be worn beneath clothing without being noticeable.

In accordance with one embodiment, the invention relates to a body movement sensing apparatus comprising:
a thin, flexible, resilient pad;
a layer of adhesive on one surface of the pad for releasably attaching the pad to a human body;
at least one flexible movement sensor embedded in the pad for flexing with the pad when an area of the body moves beneath the pad;
a source of electrical power connected to the at least one sensor for powering the sensor; and
an indicator connected to the at least one sensor for providing an indication of movement of the area of the body exceeding a predetermined limit.

In accordance with another embodiment, the invention relates to a body movement sensing apparatus comprising:
a thin flexible resilient pad;
a layer of adhesive on one surface of the pad for releasably attaching the pad to a human body; and
at least one resilient movement sensor embedded in the pad for flexing when an area of the body moves beneath the pad and for providing an audible signal when flexing and returning to a rest position.

### BRIEF DESCRIPTION OF DRAWINGS

The invention is described in greater detail with reference to the accompanying drawings, which shows the preferred embodiments of the invention, and wherein:

FIG. 1 is a perspective view of a first embodiment of a body movement sensing apparatus in accordance with the present invention;

FIG. 2 is a perspective view of a pad used in the apparatus of FIG. 1;

FIG. 3 is a top view of the second embodiment of the apparatus of the present invention;

FIG. 4 is a top view of a pad for use in the apparatus of the present invention;

FIG. 5 is a side view of the pad of FIG. 4;

FIGS. 6 and 7 are top and end views, respectively of another pad for use in the apparatus of the present invention;

FIGS. 8 and 9 are top and end views, respectively of yet another pad for use in the apparatus of the present invention;

FIGS. 10 and 11 are top and end views, respectively of the pad of FIGS. 4 and 5 showing a sensor array;

FIGS. 12 and 13 are top views of the pad of FIG. 4 showing alternative forms of the sensor array;

FIGS. 14 and 15 are top views of two apparatuses in accordance with the present invention in use positions;

FIG. 16 is a perspective view of the apparatus of FIGS. 8 and 9 in a use position;

FIG. 17 is an isometric view of a third embodiment of the sensing apparatus of the present invention;

FIG. 18 is an end view of the sensing apparatus of FIG. 17;

FIG. 19 is a longitudinal sectional view of the apparatus of FIGS. 17 and 18;

FIG. 20 is a perspective view of a fourth embodiment of the body movement sensing apparatus in accordance with the present invention;

FIG. 21 is a top view of the apparatus of FIG. 20;

FIG. 22 is a side view of the apparatus of FIGS. 20 and 21;

FIG. 23 is an exploded, isometric view of the apparatus of FIGS. 20 to 22;

FIG. 24 is an isometric view of a fifth embodiment of the body movement sensing apparatus of the present invention;

FIG. 25 is a side view of the apparatus of FIG. 24; and

FIG. 26 is a top view of the apparatus of FIGS. 3 and 24.

### BEST MODES FOR CARRYING OUT INVENTION

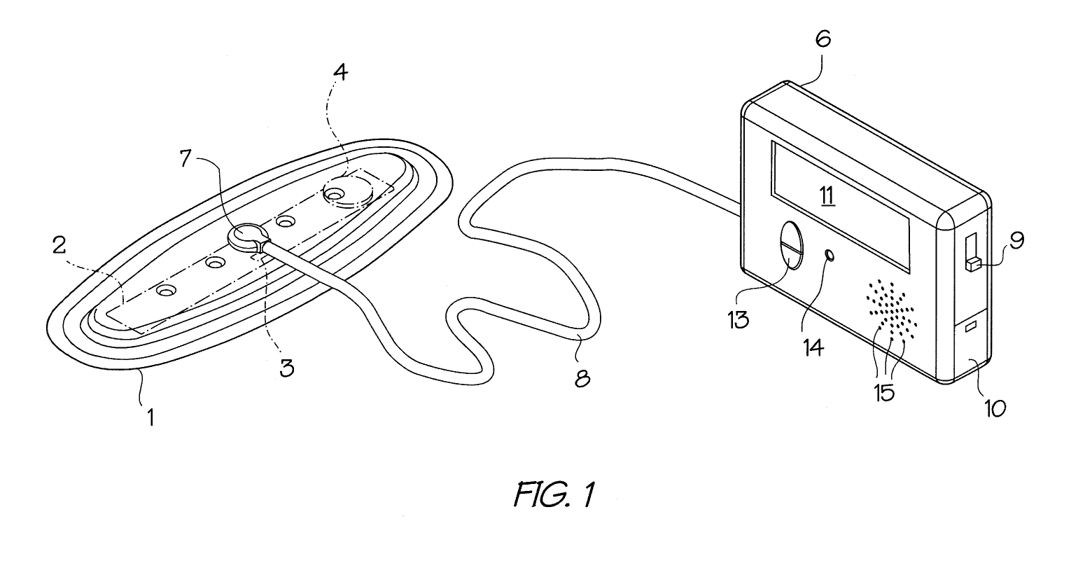

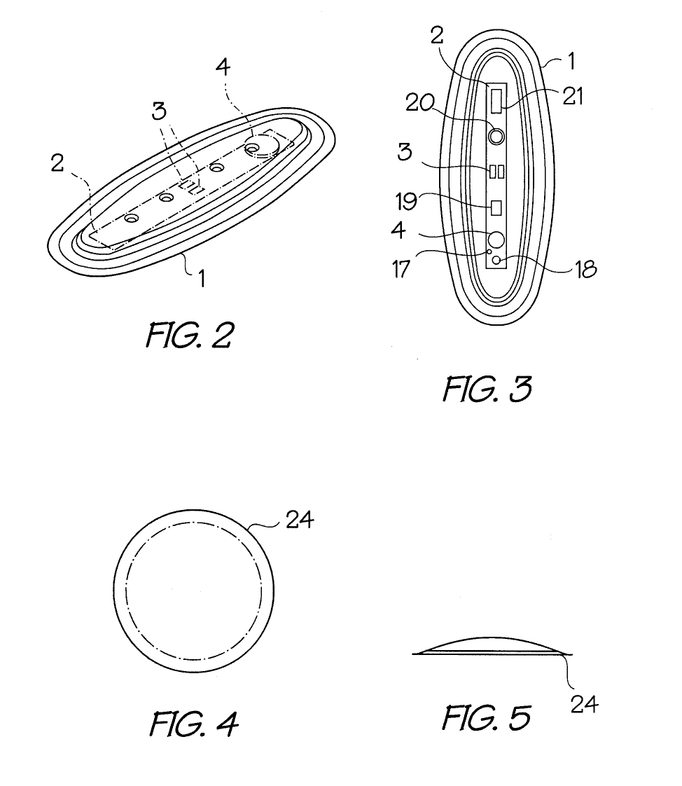

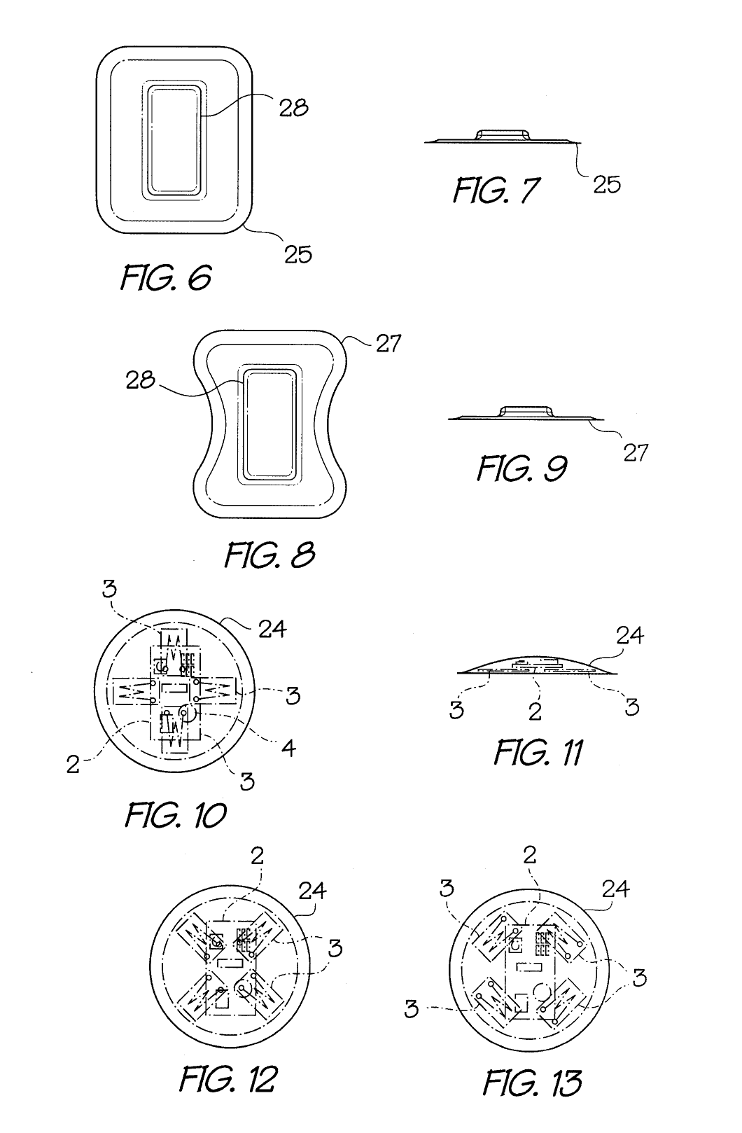

Referring to FIG. 1, one form of the apparatus in accordance with the present invention includes a flexible, oval pad 1 containing a printed circuit board 2 carrying at least one sensor array 3 and a battery 4. The sensor array 3 is connected to a control box 6 by an adaptor 7 and a cable 8. The control box 6, which can be approximately the same size as a pager, contains a power (on/off) switch 9, a battery compartment (not shown) closed by a door 10, an LCD or LED screen 11 with a battery indicator, select and set buttons 13 and 14, and an audible alarm (not shown) behind openings 15 in the box.

With reference to FIG. 2, the pad 1 is formed of a thin, flexible, resilient rubber or plastic which can stretch with the skin without causing discomfort to a wearer. A resilient adhesive on the bottom of the pad holds the pad on the person's skin. The printed circuit board 2, like the pad 1, is also formed of a flexible, resilient material.

Another, self-contained embodiment of the invention which is used without the control box 6 is illustrated in FIG. 3 of the drawings. The self-contained apparatus of FIG. 3 includes a thin, flexible, resilient, transparent pad 1 and a printed circuit board 2 carrying sensors 3. The printed circuit board 2 also carries a recessed on/off button 17 and a set point button 18, a battery 4, a microprocessor 19 for receiving signals from the sensor 3 and triggering an alarm 20, and a liquid crystal display 21 which is activated by the microprocessor 19. A slit (not shown) provided in the pad 1 permits access to the battery 4 for replacement purposes. The set point button 18 is used to set the level or degree of detected movement or strain which is required to trigger the alarm 20. The alarm 20 can be a buzzer or other audible device or a vibrator. The display 21 provides a visual indication of the level of strain or movement of a body part beneath the pad 1 or a visual indication that a predetermined strain has been exceeded.

Referring to FIGS. 4 to 9, the flexible pad can have various configurations, including the circular pad 24 illustrated in FIGS. 4 and 5, the rectangular pad 25 illustrated in FIGS. 6 and 7, and the generally hourglass shaped pad 27 illustrated in FIGS. 8 and 9. The round pad 24 is domed, and the pads 25 and 27 have rectangular central projections 28 for housing the printed circuit board, sensors and the other elements illustrated in FIG. 3. The pads 24, 25 and 27 are intended for use with or without a remote control unit. Accordingly, the pads contain sensors and when used with a remote control, the pad contains sensors, a source of power and a antenna for transmitting a wireless signal to a remote control unit.

FIGS. 10 to 13 illustrate a plurality of sensor 3 connected to a printed circuit board 2 in a circular pad 24. The sensor can be arranged in a variety of different positions in the pad 24, depending upon the area of the body on which the pad is to be mounted and the type of motion to be detected. The sensors 3 illustrated in FIGS. 10 to 13 are in the form of Wheatstone bridges. As is known to those skilled in the art to which this invention relates, a Wheatstone bridge is a network of resistive legs, one or more of which can be active sensing elements. When a change of strain is applied to the bridge, the resistance of each sensing element changes. There are several types of strain gauge designs and configurations in the Wheatstone bridge, and depending on the bridge configuration, the sensors can measure axial strain, bending strain, or both.

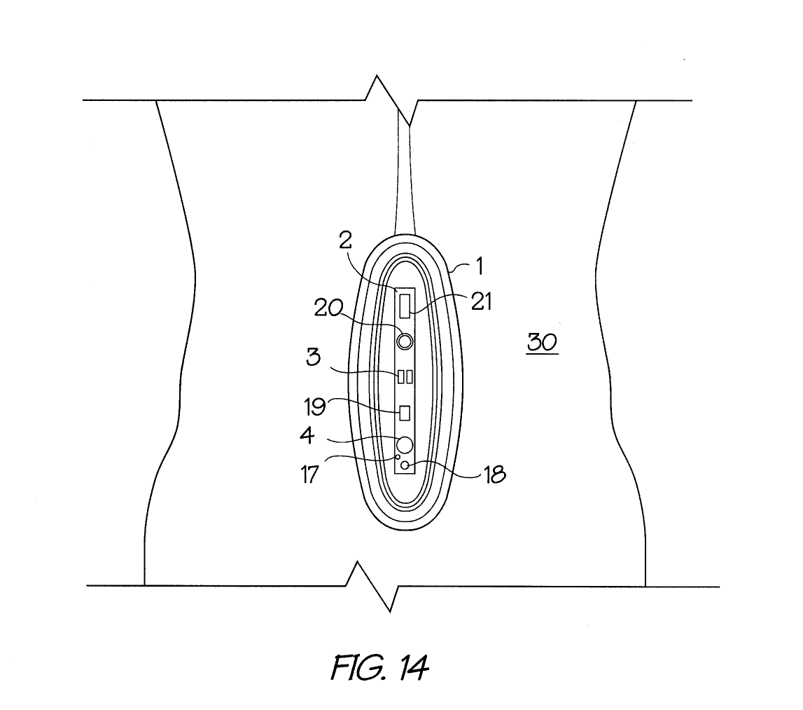

FIGS. 14 to 16 illustrate the use of the apparatus of the present invention. In FIG. 14, an oval pad 1 is mounted in the lower back area of a person 30. The apparatus of FIG. 14 measures twisting and bending of the lower back with a view to preventing back injury.

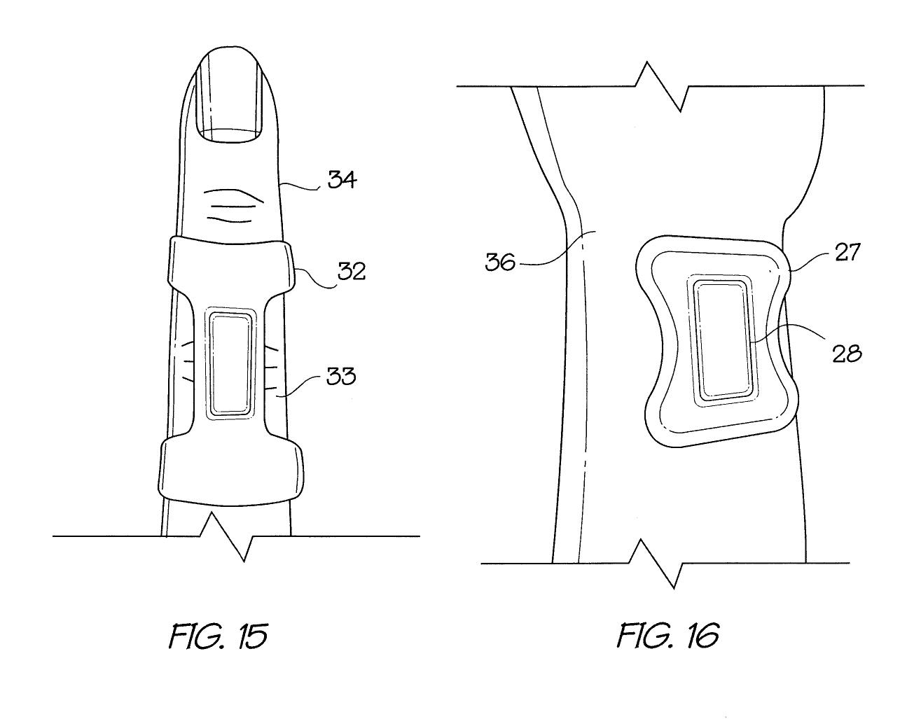

FIG. 15 illustrates the use of a generally I-beam shaped pad 32 on the knuckle 33 of a finger 34 for measuring the degree of bending of the finger. The hourglass-shaped pad 27 illustrated in FIG. 16 is shown mounted on a person's wrist 36 for measuring bending and rotation of the wrist.

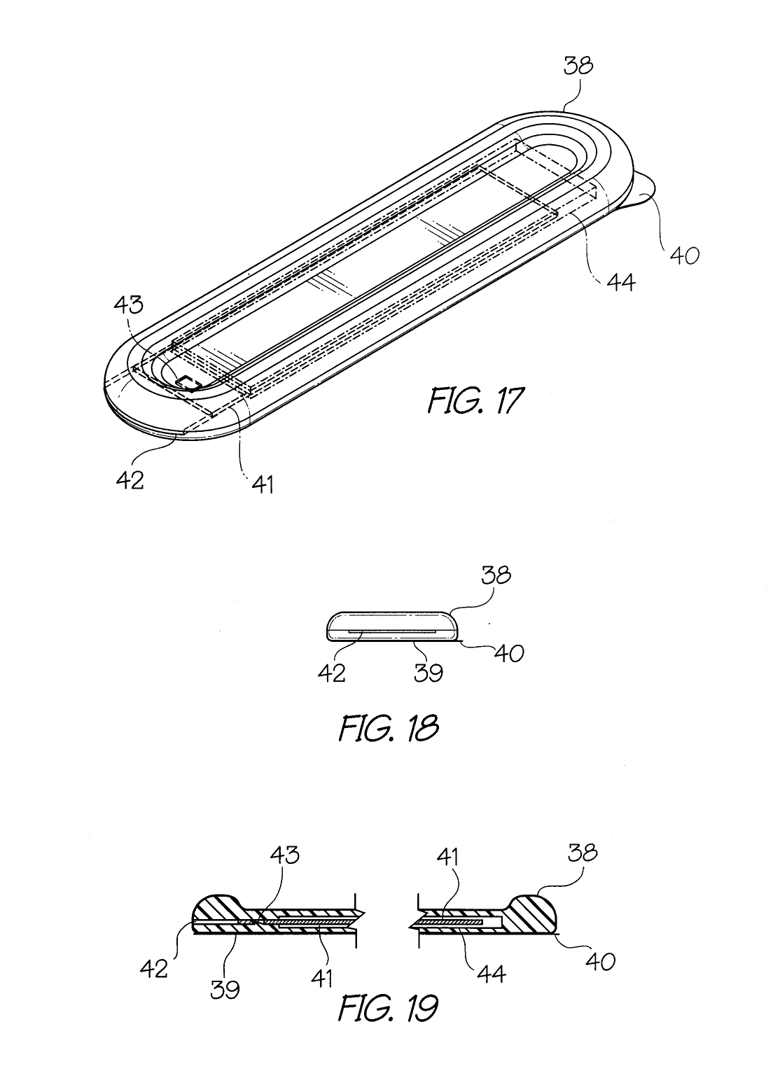

With reference to FIGS. 17 to 19, a third embodiment of the invention includes a thin, flexible rubber or plastic pad 38 which can stretch with the skin. A thin layer of resilient adhesive on the bottom of the pad 38 holds the pad on a person's skin. Until the pad 38 is being applied to the skin, the adhesive is protected by a thin strip of plastic 39, which has an ear or tab 40 extending outwardly from one end of the pad 38. A thin, resilient strip 41 of spring steel is inserted through a slot 42 in one end of the pad 38.

One end of the strip 41 is retained in the slot 38 by a small triangular projection or detent 43 in the interior of the pad 38. The remainder of the strip 41 extends into a large cavity 44 in the pad 38. The strip 41 is intended to make a noise when bent or flexed in one direction and when returned to its normal rest position. Spring steel strips have been used in a variety of noise makers. Thus, the strip 41 provides an audible signal that the area under the pad 40 has been bent or flexed beyond a predetermined limit. It will be appreciated that while spring steel is the preferred material for the strip 41, other materials which produce a noise when bent can also be used.

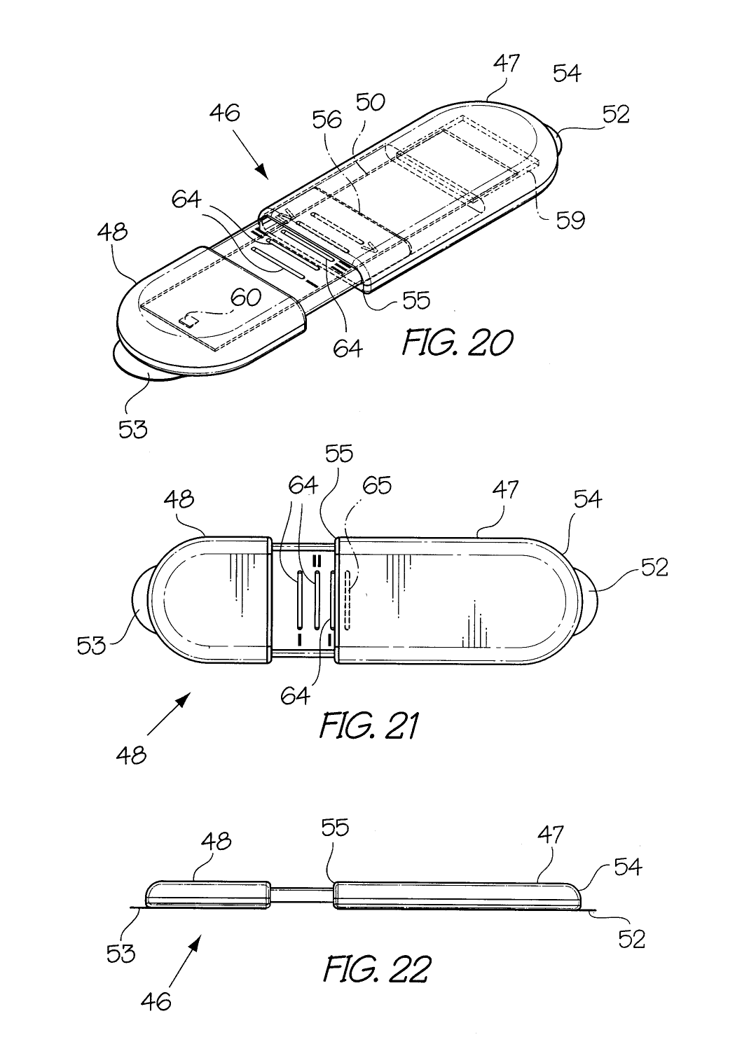

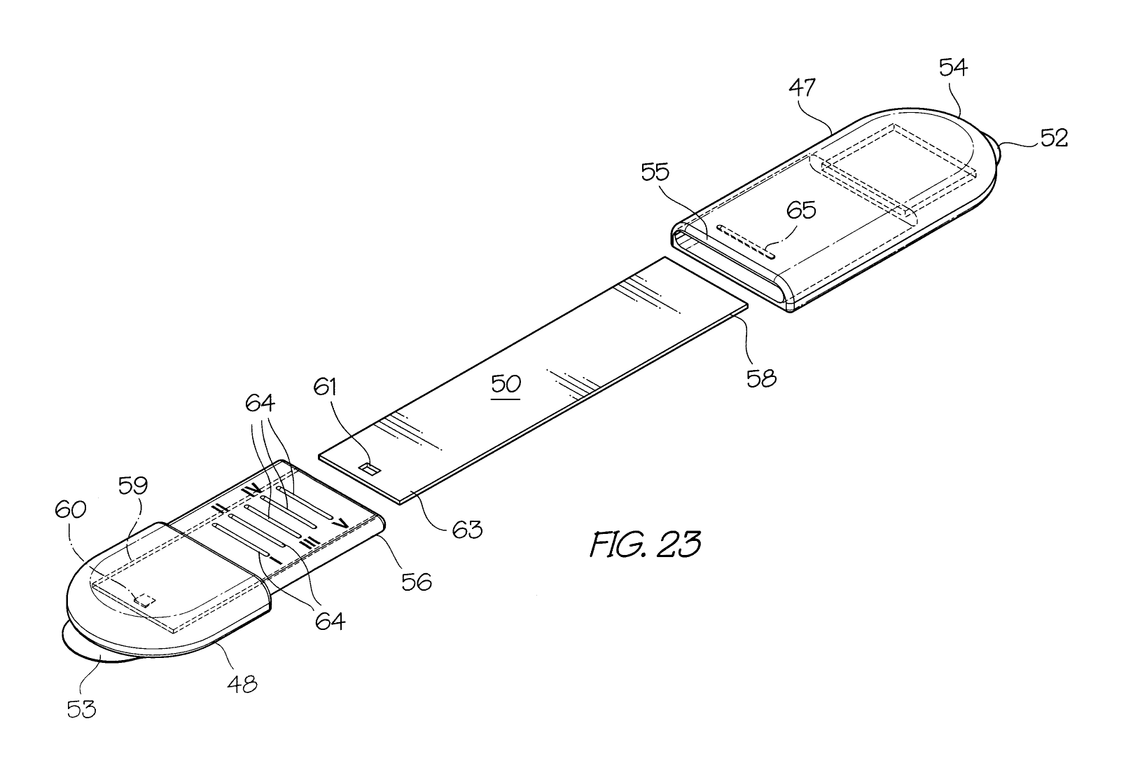

Referring to FIGS. 20 to 23, a fourth embodiment of the invention includes a two-piece, oval pad indicated generally at 46, which is defined by a thin, flexible, generally U-shaped socket 47 (when viewed from above or below) and a flexible insert 48 containing a resilient strip 50 of spring steel for insertion into the socket 47. Both the socket 47 and the insert 48 are formed of flexible plastic. The bottom surfaces of the socket 47 and the insert 48 are coated with flexible adhesive and, prior to application to a body, the adhesive is covered by removable plastic strips 52 and 53, respectively. The socket 47 includes a closed semicircular end 54 and an open end 55 for receiving one end 56 (FIG. 20) of the insert 48 and the free end 58 (FIG. 23) of the strip 50. The cavity in the socket 47 is larger at the open end 55 than at the closed end 56 thereof, so that when the free end 58 of the strip 50 is slid into the socket, the free end enters the smaller end of the cavity.

The resilient strip 50 is retained in a slot 59 in the insert 48 by a projection or detent 60 which enters an opening 61 in the second end 63 of the strip when the latter is pressed into the insert. A plurality of transversely extending straight recesses 64 in the smaller end 56 of the insert 48 are designed to receive a transversely extending detent 65 in the open end 55 of the socket 47 for releasably latching the insert in a variety of positions in the socket 47. The recesses 64 and the detent 65 permit adjusting of the length of the smaller end 55 of the insert 48 exposed, i.e. not contained in the socket 47.

In use, when the area beneath the sensor flexes, the exposed position of the smaller end 55 of the insert 48 and the metal strip 50 also flex making a noise. The longer the exposed portion of the insert end 55, the greater the angle by which the insert 48 and the strip 50 can flex with respect to the socket 47. The Roman numerals I-V at the ends of the recesses 64 correspond to limit angle positions of 5, 15, 30, 45 and 60 degrees, respectively.

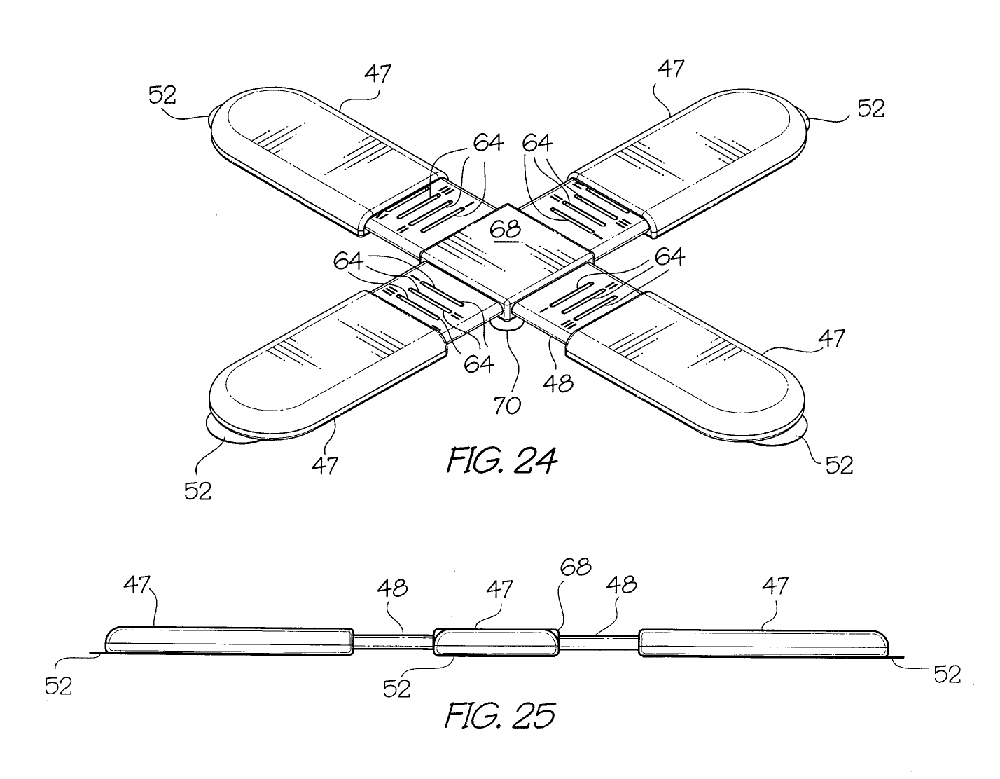

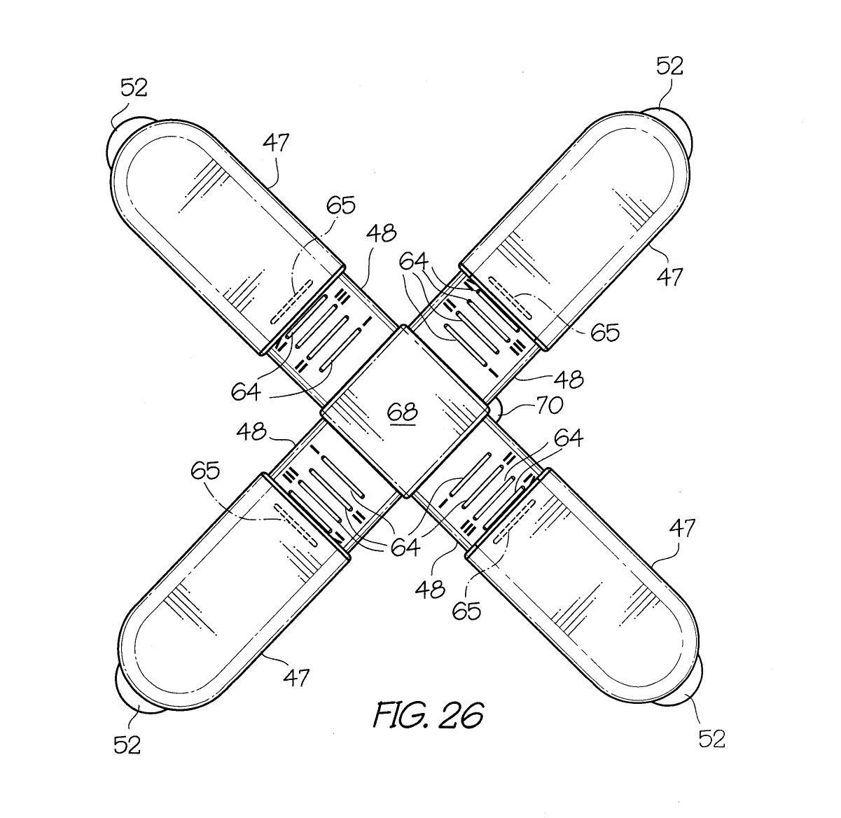

In the following description of FIGS. 24 to 26, wherever possible the same reference numerals have been used to identify elements corresponding to the same or similar elements shown in FIGS. 20-23.

The monitoring apparatuses of FIGS. 24 to 26 include four sockets 47 and a central hub 68 with four inserts 48 extending outwardly therefrom. Four spring steel strips (not shown) are anchored in the hub 68 in the same manner as in the insert of FIGS. 20 to 23, i.e. the hub 68 performs the function of four insert ends. Adhesive is provided on the bottom surface of each socket 47 and on the bottom of the square hub 68. The adhesive is covered by removable plastic strips 52 and 70. The apparatus functions in the same manner as the apparatus of FIGS. 20 to 23, except by flexing of the area beneath the apparatus can be monitored in four directions from the hub 68. It will be appreciated that three to six or more arms can extend outwardly from a central hub 68.

Important features of the apparatus of the present invention are as follows:
the apparatus can be worn in a variety of locations on the body regardless of the activity, and will not show when worn beneath clothing,
the control box of the first embodiment of the invention can include elements for sending a wireless signal to a monitoring station to provide a signal that the wearer has moved, twisted or bent a portion of the anatomy beyond a predetermined desirable limit, and
because a suitable adhesive is used on the pad, the sensor can be removed and replaced a number of times.

1. A body movement sensing apparatus comprising:
a thin, flexible, resilient pad;
a layer of adhesive on one surface of the pad for releasably attaching the pad to a human body;
at least one flexible movement sensor embedded in the pad for flexing with the pad when an area of the body moves beneath the pad;
a source of electrical power connected to the at least one sensor for powering the sensor; and
an indicator connected to the at least one sensor for providing an indication of movement of the area of the body exceeding a predetermined limit.

2. The sensing apparatus of claim 1 including a printed circuit in said pad; said printed circuit carrying said at least one sensor, the source of power and the indicator.

3. The sensing apparatus of claim 2 including a flexible printed circuit board carrying said printed circuit.

4. The sensing apparatus of claim 3, wherein said printed circuit board carries an on/off button, a set point button and a microprocessor for receiving signals from the at least one sensor and triggering the indicator.

5. The sensing apparatus of claim 4 including a slit in said pad permitting access to the source of power.

6. The sensing apparatus of claim 5, wherein the source of power is a battery.

7. The sensing apparatus of claim 2 including a remote control unit separate from said pad, said control unit containing said source of power, a power control switch connected to said source of power, and said indicator, the indicator being connected to said at least one sensor.

8. The sensing apparatus of claim 7, wherein said source of power is a battery, and the indicator is an audible or visible alarm or a vibrator.

9. The sensing apparatus of claim 8, wherein the indictor is a liquid crystal display for providing a visible indication of a level of movement of a body part beneath the pad or a visible indication that a predetermined strain has been exceeded.

10. The sensing apparatus of claim 9, wherein said pad contains an antenna for transmitting a wireless signal to said remote control unit.

11. The sensing apparatus in any one of claims 1 to 10, wherein said at least one sensor is a Wheatstone bridge.

12. The sensing apparatus of claim 10 including a plurality of Wheatstone bridges for measuring at least one of axial strain and bending strain in the area of the body beneath the sensors.

13. A body movement sensing apparatus comprising:
a thin, flexible, resilient pad;
a layer of adhesive on one surface of the pad for releasably attaching the pad to a human body;
a printed circuit board embedded in the pad;
a plurality of flexible Wheatstone bridge movement sensors carried by the printed circuit board and embedded in the pad for flexing with the pad when an area of the body moves beneath the pad;
a battery embedded in the pad and connected to the sensors for powering the sensors;
a microprocessor on the printed circuit board for receiving signals from the sensors; and
an alarm carried by the printed circuit board and connected to the microprocessor for providing an indication of movement of the area of the body exceeding a predetermined limit.

14. A body movement sensing apparatus comprising:
a thin flexible resilient pad;
a layer of adhesive on one surface of the pad for releasably attaching the pad to a human body; and
at least one resilient movement sensor embedded in the pad for flexing when an area of the body moves beneath the pad and for providing an audible signal when flexing and returning to a rest position.

15. The sensing apparatus of claim 14, wherein said pad includes a socket having cavity therein, and an insert carrying said movement sensor slidable in said socket, permitting adjustment of the flex length of the insert and sensor.

16. The sensing apparatus of claim 15, wherein said movement sensor is a spring steel strip, which makes a noise when flexed.

17. The sensing apparatus of claim 15, wherein said pad includes a central hub; a plurality of arms extending outwardly from said hub, each arm defining an insert; a movement sensor carried by each insert; and a socket on outer free end of each insert.
